(19) United States
(12) Patent Application Publication
(10) Pub. No.: US 2026/0287727 A1
(43) Pub. Date: Sep. 24, 2026

(54) DETECTION OF OBJECTS BEHIND METAL BARRIERS USING PLASMONIC ANTENNAS

(71) Applicant: Saltenna Inc., McLean, MD (US)

(72) Inventors: Igor SMOLYANINOV, Columbia, MD (US); Quirino BALZANO, Annapolis, MD (US)

(21) Appl. No.: 19/149,256

(22) PCT Filed: Mar. 19, 2025
(86) PCT No.: PCT/US2025/020593

§ 371 Date: Jul. 18, 2025

(51) Int. Cl. G01S 13/04

(52) U.S. Cl. CPC G01S 13/04

(57) ABSTRACT

Plasmonic radar systems and related methods are described. In some examples, a first plasmonic antenna may induce plasmon signals propagating on a first surface of a metal barrier and around the barrier to a second surface opposite the first. A second plasmonic antenna may detect the plasmon signals propagating on both surfaces of the metal barrier. A processor may analyze variations in the detected plasmon signals to determine the presence and position of an object behind the metal barrier. The system may enable detection of objects obscured by metal barriers, with sensitivity to lateral and depth positions based on signal frequency and response characteristics.

### FIELD OF TECHNOLOGY

The present disclosure relates generally to radar systems, and more specifically to detection of objects behind metal barriers using plasmonic antennas.

### BACKGROUND

Ground penetrating radar (GPR) systems may utilize electromagnetic waves to detect and image objects located beneath surfaces or within structures. These systems may operate by transmitting signals through materials and analyzing the reflected signals to identify subsurface features or objects. GPR systems may employ broadband or narrowband antennas to transmit and receive signals across a range of frequencies, enabling the detection of objects at various depths. The transmitted signals may interact with materials differently based on their composition, allowing for the identification of changes in material properties or the presence of hidden objects. Applications of GPR may include geological surveys, utility mapping, structural inspections, and security operations. Signal analysis techniques may involve measuring parameters such as return loss or signal transmission between antennas to extract spatial and material information.

The described implementations relate to improved radar systems and associated methods for detection of objects behind metal barriers with plasmonic antennas. Some implementations may address the limitations of conventional ground-penetrating radar systems by employing plasmonic antennas and a vector network analyzer to measure S21 and S11 signals. Plasmonic antennas may be capable of generating and receiving plasmonic signals that may travel around metal objects, thereby enabling the detection of objects or motion behind metal barriers. The vector network analyzer may be used to analyze the frequency-dependent variations in the S21 and S11 signals, which may be indicative of the presence and position of objects behind the metal barrier.

By analyzing the S21 signal, the system may determine the lateral (XY) position of objects behind the metal plate, while the frequency response of the S21 signal may provide information about the depth (Z) position. This dual capability may allow for accurate localization of objects in three dimensions, overcoming the limitations of traditional ground-penetrating radar systems in conductive environments. Some implementations may provide a robust and reliable solution for detecting objects or motion behind metal barriers, making them suitable for a wide range of applications, including security, search and rescue, and industrial inspections.

A plasmonic radar system is described. The system may include a first plasmonic antenna configured to induce plasmon signals propagating on a first surface of a metal barrier in response to being positioned proximate to or abutting the metal barrier, the plasmon signals propagating around the metal barrier to a second surface of the metal barrier, the second surface being opposite the first surface. The system may include a second plasmonic antenna configured to detect the plasmon signals propagating on the first surface of the metal barrier and from the second surface of the metal barrier. The system may include a processor configured to analyze variations in the detected plasmon signals to determine a presence of an object behind the metal barrier based on the variations.

A method of forming a plasmonic radar system is described. The method may include positioning a first plasmonic antenna proximate to or abutting a metal barrier, the first plasmonic antenna being configured to induce plasmon signals propagating on a first surface of the metal barrier, the plasmon signals may propagate around the metal barrier to a second surface of the metal barrier, the second surface may be opposite the first surface. The method may include arranging a second plasmonic antenna to detect the plasmon signals propagating on the first surface of the metal barrier and from the second surface of the metal barrier. The method may include configuring a processor to analyze variations in the detected plasmon signals to determine a presence of an object behind the metal barrier based on the variations.

Some examples of the technologies and related methods described herein may further include a housing configured to position the first plasmonic antenna and the second plasmonic antenna proximate to the metal barrier.

In some examples of the technologies and related methods described herein, the processor may be further configured to analyze variations in high-frequency plasmon signals to enhance the detection of motion behind a metal screen.

In some examples of the technologies and related methods described herein, the processor may be further configured to analyze variations in low-frequency plasmon signals to enhance the detection of motion behind a metal screen.

In some examples of the technologies and related methods described herein, the processor may be further configured to analyze the high-frequency plasmon signals and the low-frequency plasmon signals to determine a distance of the object from the metal barrier.

In some examples of the technologies and related methods described herein, the processor may be further configured to determine the detection of motion behind a metal screen based on the frequency response of the detected plasmon signals.

In some examples of the technologies and related methods described herein, the processor may be further configured to determine a position of the object behind a metal screen based on a frequency response of the detected plasmon signals.

Some examples of the technologies and related methods described herein may further include a display configured to visually represent the presence of an object behind the metal barrier based on the analyzed variations.

Some examples of the technologies and related methods described herein may further include a display configured to visually present the detection of motion behind a metal screen based on the analyzed variations.

In some examples of the technologies and related methods described herein, the processor may be further configured to analyze variations in the detected plasmon signals to distinguish between stationary and moving objects behind the metal plate.

In some examples of the technologies and related methods described herein, the processor may be further configured to analyze variations in the detected plasmon signals to identify multiple objects behind the metal plate.

In some examples of the technologies and related methods described herein, the processor may be further configured to analyze variations in the detected plasmon signals to determine the size of an object behind the metal plate.

In some examples of the technologies and related methods described herein, the processor may be further configured to analyze variations in the detected plasmon signals to differentiate between high frequency plasmon and low frequency plasmon responses.

In some examples of the technologies and related methods described herein, the processor may be further configured to analyze variations in the detected plasmon signals to determine the relative speed of motion of an object behind the metal plate.

In some examples of the technologies and related methods described herein, the processor may be further configured to analyze variations in the detected plasmon signals to provide a three-dimensional representation of motion behind the metal plate.

### BRIEF DESCRIPTION OF THE DRAWINGS

FIG. 1 illustrates a system that demonstrates the concept of surface electromagnetic waves (SEWs), in accordance with one or more implementations.

FIG. 2 shows a plasmonic GPR system which supports techniques for detection of objects behind metal barriers with plasmonic antennas in accordance with various aspects of the present disclosure.

FIG. 3 shows a sideview of a plasmonic GPR system which supports techniques for detection of objects behind metal barriers with plasmonic antennas in accordance with various aspects of the present disclosure.

FIG. 4 shows a graph illustrating the excitation of plasmon waves over the surface, which may be used for detection of objects and motion behind a metal screen in accordance with various aspects of the present disclosure.

FIG. 5 shows a graph illustrating the frequency response of the S21 gain (in decibels) as a function of frequency (in gigahertz) in accordance with various aspects of the present disclosure.

FIG. 6 shows a flowchart illustrating a method involving detection of objects behind metal barriers with plasmonic antennas in accordance with various aspects of the present disclosure.

### DETAILED DESCRIPTION

The described implementations relate to improved radar systems and associated methods for detection of objects behind metal barriers with plasmonic antennas. In some examples, conventional ground penetrating radar systems are ineffective in detecting objects or motion behind metal barriers due to the high reflectivity and signal attenuation of metal. This limitation poses a significant challenge in various applications, such as security screening, search and rescue operations, and industrial inspections, where the ability to see through metal is crucial. The inability to penetrate metal barriers with traditional ground penetrating radar technology results in a lack of situational awareness and may lead to missed detections or false negatives. Therefore, there is a need for an advanced detection system that can overcome the limitations of conventional ground penetrating radar and provide reliable detection of objects or motion behind metal barriers.

According to some implementations, radar systems may utilize plasmonic antennas and a vector network analyzer to detect objects or motion behind metal barriers. These systems may employ plasmonic antennas designed to transmit and receive electromagnetic waves in a plasmonic form, allowing signals to travel around and behind metal objects. The plasmonic antennas may be connected to a vector network analyzer, which may measure signal parameters such as S21 and S11.

The S21 signal may represent the transmission received by the second plasmonic antenna when the first antenna transmits, capturing both the direct crosstalk and any signal that propagates behind the metal barrier. The S11 signal may measure the return loss, which may be the portion of the transmitted signal that is reflected back to the transmitting antenna.

By analyzing variations in the S21 and S11 signals, the system may detect objects or motion behind metal barriers. Motion or the presence of an object behind the metal barrier may cause noticeable changes in the S21 signal, while the S11 signal may show smaller but detectable variations.

The system may analyze the frequency response of the S21 signal to determine the depth (Z position) of objects behind the metal barrier. Different frequencies may propagate differently, allowing the system to extract spatial information about the object's position. The S21 signal may also be sensitive to the lateral position (XY) of objects behind the metal barrier, enabling the system to recover the XY position by analyzing signal variations.

The system may be compatible with both broadband and narrowband plasmonic antennas. Broadband antennas may allow for the analysis of a wide range of frequencies, while narrowband antennas may focus on specific frequency ranges. Both configurations may demonstrate clear responses to motion and object detection behind metal barriers.

Plasmonic signals may travel around metal objects, enabling detection in environments where conventional ground penetrating radar systems may fail. This capability may allow the system to overcome limitations in conductive environments. The system may provide real-time detection of motion or objects behind metal barriers, with changes in the S21 signal displayed live on a computer screen for immediate identification.

The system may be configured to detect motion by setting a threshold for signal changes. When signal variations may exceed the threshold, the system may trigger an alert, such as flashing a red light, to indicate motion behind the metal barrier. The system may be enhanced to provide a visual representation of the detected object's position. By correlating signal variations with the physical dimensions of the metal barrier, the system may map the object's location relative to the barrier.

The system may operate across multiple frequencies to improve depth sensing capabilities. By analyzing signal variations at different frequencies, the system may determine the Z position of objects with greater accuracy. The system may be adaptable to various types of metal barriers, including metal screens and large metal doors, ensuring applicability in diverse environments and scenarios.

The system may be sensitive to the position and motion of objects behind the metal barrier. Changes in the S21 signal may vary depending on the object's location, allowing for precise detection and tracking. The system may be scalable from simple motion detection to more complex applications, such as mapping the position of objects behind metal barriers. A basic implementation may involve a simple motion detector with a visual or auditory alert, while a more advanced system may include detailed position mapping.

The detection range of the system may depend on the wavelength of the signal used. Higher frequencies (shorter wavelengths) may be sensitive to objects closer to the barrier, while lower frequencies (longer wavelengths) may detect objects further behind the barrier. The system may incorporate computational signal processing to enhance detection accuracy. By applying algorithms similar to those used in conventional ground penetrating radar systems, the system may process signal variations to provide detailed spatial information about objects behind the barrier.

A prototype of the system may be demonstrated using a laptop connected to the vector network analyzer and plasmonic antennas. The prototype may successfully detect motion and objects behind metal barriers, validating the system's core functionality. The system may require minimal hardware, consisting of plasmonic antennas, a vector network analyzer, and a computer for signal analysis and visualization. This simplicity may make the system cost-effective and easy to deploy.

Unlike conventional ground penetrating radar systems, which may be ineffective in conductive environments, some implementations may leverage plasmonic signals to detect objects and motion behind metal barriers. This capability may address a limitation of traditional ground penetrating radar technology.

Aspects of the subject matter described in this disclosure can be implemented to realize one or more of the following potential advantages. The described techniques may be implemented to support enhanced security measures by detecting unauthorized personnel behind metal barriers. The system may be utilized in various environments, such as industrial facilities, military installations, and secure buildings, where monitoring behind metal barriers is critical. The use of plasmonic antennas may enable the detection of objects and motion in scenarios where traditional radar systems may fail due to the conductive nature of metal. The system may offer real-time monitoring capabilities, providing immediate feedback and alerts to security personnel. By leveraging the frequency response of the S21 signal, the system may accurately determine the position and movement of objects, enhancing situational awareness. The scalability of the system may allow for both simple and complex implementations, catering to different security needs and operational requirements. The cost-effectiveness and ease of deployment may make the system an attractive solution for a wide range of applications, from basic motion detection to advanced spatial mapping behind metal barriers.

Aspects of the disclosure are initially described in the context of radar systems. Aspects of the disclosure are additionally illustrated by and described with reference to example implementations. Aspects of the disclosure are further illustrated by and described with reference to a flowchart that relates to methods involving detection of objects behind metal barriers with plasmonic antennas.

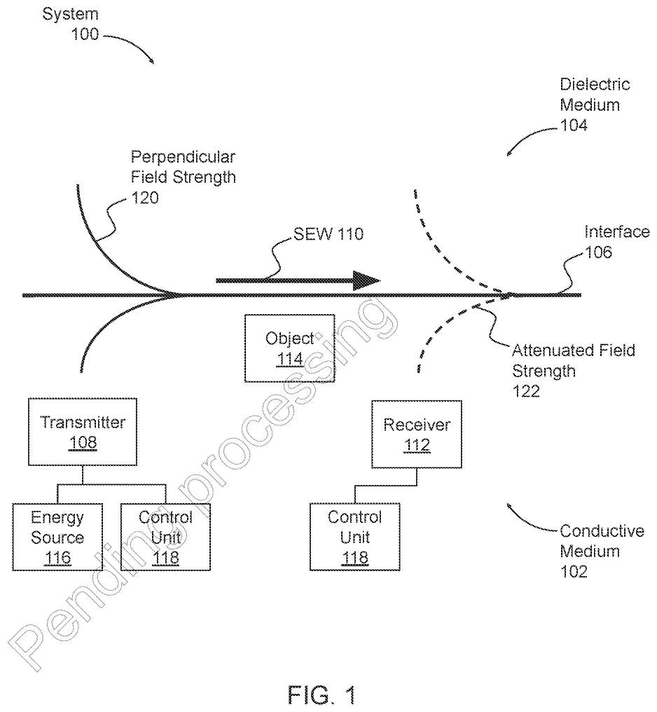

FIG. 1 illustrates a system 100 that illustrates the concept of surface electromagnetic waves (SEWs), in accordance with one or more implementations. The system 100 may include a conductive medium 102, such as a body of water, organic tissue, a metallic plane, and/or other conductive media. Adjacent to the conductive medium 102, there may be a dielectric medium 104, such as air and/or other dielectric media, which may interface with the conductive medium 102. The interface 106 between the conductive medium 102 and the dielectric medium 104 may be where SEWs are generated and may propagate.

The system 100 may also include a transmitter 108, which may be positioned near the interface 106. The transmitter 108 may be positioned within the conductive medium 102 or within the dielectric medium 104. The transmitter 108 may be responsible for generating an electromagnetic field that may induce SEW's at the interface 106 of the conductive medium 102 and the dielectric medium 104. The excited SEWs may then travel along the interface 106, as indicated by the arrow of SEW 110, which may represent the direction of wave propagation.

To help visualize the phenomenon of SEWs, one may consider an analogy to ripples on a pond. When a stone is dropped into a still pond, ripples may form and spread out across the surface of the water. Similarly, the transmitter 108 may be thought of as the stone, and the SEWs may be akin to the ripples that spread along the conductive medium 102. Just as the ripples may move outward from the point of impact, SEWs may propagate along the interface 106, carrying energy with them.

The system 100 may further include a receiver 112, which may be positioned at a distance from the transmitter 108 along the interface 106. The receiver 112 may be positioned within the conductive medium 102 or within the dielectric medium 104. The receiver 112 may be configured to receive the SEWs after they have propagated along the interface 106. This may be analogous to placing one's hand in the water at a distance from where the stone was dropped, feeling the ripples as they pass by.

Additionally, the system 100 may include an object 114 positioned within the conductive medium 102 or within the dielectric medium 104, which may be representative of an obstacle that SEWs may encounter during propagation. The interaction of SEWs with the object 114 may lead to scattering of waves, similar to how water ripples may change direction or form patterns when they encounter a leaf or a rock in the pond.

The system 100 may include an energy source 116, such as a radio frequency generator, which may be connected to the transmitter 108. The energy source 116 may provide the necessary power for the transmitter 108 to generate the electromagnetic fields that excite the SEWs. This may be thought of as the force with which the stone is thrown into the pond, affecting the size and strength of the resulting ripples.

In some implementations, the system 100 may include a control unit 118, which may be operatively coupled to the transmitter 108 and/or the receiver 112. The control unit 118 may be responsible for coordinating the generation and detection of SEWs, much like a person orchestrating the timing of stones being dropped into the pond to create a specific pattern of ripples.

From a more technical perspective, SEWs may be understood as a type of wave that propagates along the interface between two media with different dielectric properties. In FIG. 1, the conductive medium 102 and the dielectric medium 104 may form such an interface (e.g., interface 106) where SEWs may be excited and propagate. The transmitter 108 may serve as a transducer that converts electrical signals from the energy source 116 into electromagnetic fields, which may then couple to the interface 106 and give rise to SEWs.

The propagation of SEWs along the interface 106 may be characterized by a wave vector that is parallel to the interface 106. This wave vector may be larger than the wave vector of free photons in the dielectric medium 104, which may result in a confinement of the electromagnetic field to the vicinity of the interface 106. The SEW's field strength may decay exponentially in the direction perpendicular to the interface 106, as illustrated by a field strength 120 extending into the dielectric medium 104 and the conductive medium 102. These field strengths may also decay as the SEW propagates along the interface 106, as illustrated by an attenuated field strength 122. The receiver 112 may be designed to couple to these confined, attenuated fields and receive the SEWs after they have propagated along the interface 106.

The excitation of SEWs by the transmitter 108 may involve the conversion of the electromagnetic energy into a surface-bound mode, which may be facilitated by the specific design of the transmitter 108. The transmitter 108 may be optimized to match the impedance of the SEWs to maximize energy transfer into the surface wave mode. The object 114 submerged within the conductive medium 102 may introduce perturbations in the SEWs, which may be detected by the receiver 112 and analyzed by the control unit 118 to infer properties of the object 114. Examples of such properties may include one or more of size, shape, location, material properties, and/or other properties.

The mathematical description of SEWs may be derived from Maxwell's equations, which govern the properties of electromagnetic fields. The wave equation for TM-polarized SEWs may be reduced to a one-dimensional Schrödinger equation:

$$\frac{{d}^{2} ψ}{d {z}^{2}} + ( {k}^{2} - V ( z ) ) ψ = 0 \qquad ( EQN . 1 )$$

where ψ is the effective wave function introduced as E_{z}=ψ/\sqrt{ϵ}, and V(z) is the effective potential energy that guides the propagation of SEWs along the interface. The term k² may represent the total energy of the SEWs and the term ϵ may represent the dielectric permittivity of the medium.

For TE-polarized SEWs, the wave equation may not depend on the gradient term V(z) and may be expressed as:

$$\frac{{d}^{2} {E}_{z}}{{dz}^{2}} + {k}^{2} {E}_{z} = 0 \qquad ( EQN . 2 )$$

In the case of a sharp interface between two media with dielectric permittivities ϵ₁ and ϵ₂, the SEW wave vector for TM-polarized waves may be given by:

$${k}_{S E W} = \sqrt{\frac{{ω}^{2}}{{c}^{2}} \frac{{ϵ}_{1} {ϵ}_{2}}{{ϵ}_{1} + {ϵ}_{2}}} \qquad ( EQN . 3 )$$

where ω is the angular frequency of the SEWs, and c is the speed of light in vacuum.

The presence of dielectric permittivity gradients across the interface 106 may lead to additional terms in the effective potential V_{z}, which may result in the formation of a potential well that supports bound states of SEWs. These bound states may correspond to surface modes with long propagation lengths and may be excited by the transmitter 108 with appropriate impedance matching.

The system 100 may thus utilize SEWs for various applications, including communication and sensing, by exploiting the unique properties of SEWs at the interface 106 between the conductive medium 102 and the dielectric medium 104. The control unit 118 may process the received signals to extract information about the propagation and interaction of SEWs with the environment and objects within it.

In some implementations, the transmitter 108 and/or the receiver 112 may include one or more plasmonic antennas. A given plasmonic antenna may be the same as or similar to, or include one or more aspects of, the antennas disclosed in U.S. patent application Ser. No. 17/570,968 entitled “Apparatus, Methods and Systems for Electromagnetic Signal Transmission Through a Conductive Medium” filed on Jan. 7, 2022; International Application No. PCT/US2024/061379 entitled “Surface Electromagnetic Wave Antenna” filed on Dec. 20, 2024; and International Patent Application No. PCT/US2025/015358 entitled “Hybrid Antenna With Dynamic Signal Routing For Free-Space And Near-Metal Environments” filed on Feb. 11, 2025, of which the entirety is incorporated by reference for all purposes.

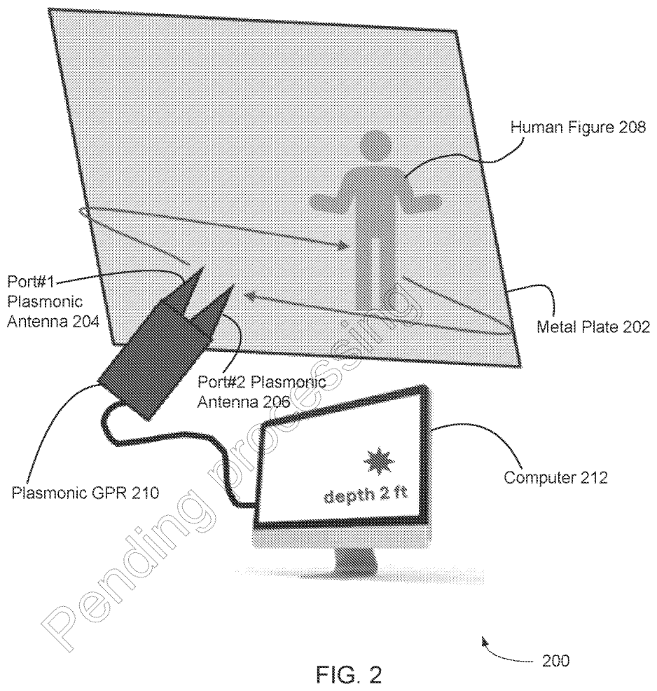

FIG. 2 shows plasmonic GPR system 200 which supports techniques for detection of objects behind metal barriers with plasmonic antennas in accordance with various aspects of the present disclosure. As depicted in FIG. 2, the plasmonic GPR detection 200 may include one or more of a metal plate 202, a port #1 plasmonic antenna 204, a port #2 plasmonic antenna 206, a human FIG. 208, a plasmonic GPR 210, a computer 212, and/or other components.

The metal plate 202 may act as a carrier for the plasmonic signals. The metal plate 202 may be composed of materials such as aluminum, steel, or other conductive metals. The metal plate 202 may have a flat or curved surface and may vary in thickness depending on the application. The metal plate 202 may interact with the plasmonic signals by inducing surface plasmons that propagate along its surface. The metal plate 202 may be positioned between the plasmonic GPR 210 and the object to be detected, such as the human FIG. 208. In some implementations, the metal plate 202 may be replaced with other conductive barriers, such as large metal doors or large metal screens.

The port #1 plasmonic antenna 204 may be connected to the plasmonic GPR 210 for signal transmission. The port #1 plasmonic antenna 204 may serve as the interface for transmitting electromagnetic signals from the plasmonic GPR 210. The port #1 plasmonic antenna 204 may be configured to handle a range of frequencies, including gigahertz and megahertz signals. The port #1 plasmonic antenna 204 may be physically attached to the plasmonic GPR 210 through a cable or other connection mechanism.

The port #2 plasmonic antenna 206 may be connected to the plasmonic GPR 210 for signal reception. The port #2 plasmonic antenna 206 may serve as the interface for receiving electromagnetic signals that have been modified by the interaction with the metal plate 202 and any objects behind it. The port #2 plasmonic antenna 206 may be configured to detect variations in the received signals, such as changes in S21 Gain. The port #2 plasmonic antenna 206 may be physically attached to the plasmonic GPR 210 through a cable or other connection mechanism. In some implementations, the port #1 plasmonic antenna 204 and the port #2 plasmonic antenna 206 may be located in various positions near the metal plate 202. For example, the port #1 plasmonic antenna 204 and the port #2 plasmonic antenna 206 may not necessarily need to be placed next to each other (unless this is needed for operational reasons).

The human FIG. 208 may represent an object behind the metal plate 202. The human FIG. 208 may be a stationary or moving object that interacts with the plasmonic signals propagating on the metal plate 202. The human FIG. 208 may cause variations in the S11 Return Loss and S21 Gain detected by the plasmonic GPR 210. The human FIG. 208 may be located at varying distances from the metal plate 202, which may affect the detected signal variations. In some implementations, the human FIG. 208 may be replaced with other objects, such as tools, equipment, or animals.

The plasmonic GPR 210 may be used to detect objects behind metal barriers. The plasmonic GPR 210 may include one or more plasmonic antennas (e.g., port #1 plasmonic antenna 204 and/or port #2 plasmonic antenna 206) configured to induce and detect surface plasmons on the metal plate 202. The plasmonic GPR 210 may be connected to a vector network analyzer to measure S11 Return Loss and S21 Gain as functions of frequency. The plasmonic GPR 210 may analyze the detected signal variations to determine the presence and position of objects, such as the human FIG. 208, behind the metal plate 202.

The computer 212 may process (e.g., using one or more internal or networked processors or processing units) and display the detection results from the plasmonic GPR 210. The computer 212 may be connected to the plasmonic GPR 210 and may visually represent the analyzed data, such as signal variations and object positions. The computer 212 may display a graphical interface that includes frequency and time axes, as well as indicators for detected objects. The computer 212 may be used to analyze and interpret the data in real-time or after processing. In some implementations, the computer 212 may be replaced with other computing devices, such as tablets or smartphones.

In some implementations, the components may be arranged such that the plasmonic GPR 210 is positioned adjacent to the metal plate 202, with port #1 plasmonic antenna 204 and port #2 plasmonic antenna 206 placed adjacent to or abutting the metal plate 202. The human FIG. 208 may be located behind the metal plate 202, representing an object whose position and movement are to be detected. The plasmonic GPR 210 may emit a signal from port #1 plasmonic antenna 204, which travels around the metal plate 202 and is received by port #2 plasmonic antenna 206. The computer 212 may be connected to the plasmonic GPR 210 to display the detected information, such as the depth of the object behind the metal plate 202.

In some implementations, the plasmonic GPR 210 may measure the S21 signal, which captures the portion of the emitted signal that propagates around the metal plate 202 and interacts with the human FIG. 208. The frequency response of the S21 signal may be analyzed to determine the depth (Z position) of the human FIG. 208 behind the metal plate 202. The computer 212 may display this information in real-time, indicating the depth of the detected object. The S11 signal, which measures the portion of the signal reflected back to port #1 plasmonic antenna 204, may also be analyzed to provide additional information about the presence and movement of the human FIG. 208.

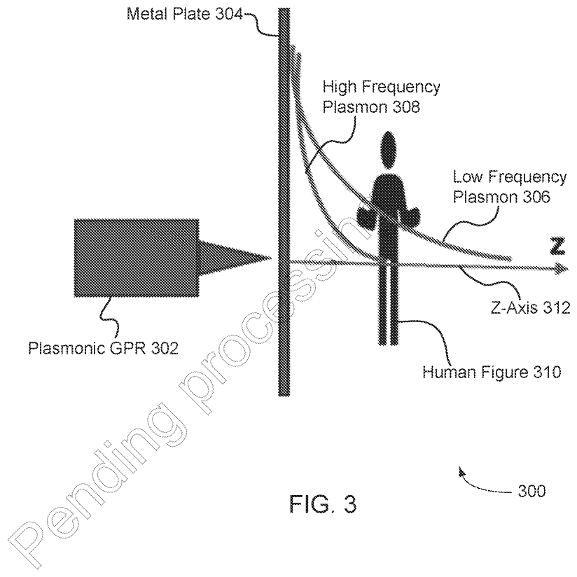

FIG. 3 shows a side view of a plasmonic GPR system 300 which supports techniques for detection of objects behind metal barriers with plasmonic antennas in accordance with various aspects of the present disclosure. As depicted in FIG. 3, the plasmonic GPR detection 300 may include one or more of a plasmonic GPR 302, a metal plate 304, a low frequency plasmon 306, a high frequency plasmon 308, a human FIG. 310, the z-axis 312, and/or other components.

The plasmonic GPR 302 may include a system for detecting objects behind metal barriers. In some implementations, the plasmonic GPR 302 may be the same as or similar to the plasmonic GPR 210, as described herein.

The metal plate 304 may represent a barrier around which the plasmonic signals travel. In some implementations, the metal plate 304 may be the same as or similar to the metal plate 202, as described herein.

The low frequency plasmon 306 may be used to detect objects at greater distances behind the metal plate 304. The low frequency plasmon 306 may correspond to electromagnetic waves with frequencies in the range of 50 MHz to 100 MHz. The low frequency plasmon 306 may propagate around the metal plate 304 and interact with objects located several meters behind it. The low frequency plasmon 306 may be generated by the plasmonic GPR 302 and may be detected by the same system. In some implementations, alternative frequency ranges may be used to achieve similar detection capabilities.

The high frequency plasmon 308 may be used to detect objects at closer distances behind the metal plate 304. The high frequency plasmon 308 may correspond to electromagnetic waves with frequencies in the range of 1 GHz or higher. The high frequency plasmon 308 may be sensitive to objects located within 20 centimeters behind the metal plate 304. The high frequency plasmon 308 may be generated and detected by the plasmonic GPR 302. In some implementations, other frequency ranges may be employed to detect objects at similar close distances.

The human FIG. 310 may represent a target object behind the metal plate 304. In some implementations, the human FIG. 310 may be the same as or similar to the human FIG. 208, as described herein.

The z-axis 312 may indicate the depth position of the detected object behind the metal plate 304. The z-axis 312 may correspond to the distance between the metal plate 304 and the detected object. The z-axis 312 may be determined by analyzing the frequency response of the S21 Gain measured by the vector network analyzer. The z-axis 312 may allow for the identification of objects at varying depths behind the metal plate 304. In some implementations, alternative methods may be used to determine the depth position of the detected object.

In some implementations, the plasmonic GPR 302 may be positioned on one side of the metal plate 304, emitting signals that interact with the metal barrier. The low frequency plasmon 306 and high frequency plasmon 308 may travel around the metal plate 304, with the low frequency plasmon 306 following a broader path and the high frequency plasmon 308 following a more confined path. The human FIG. 310 may be located behind the metal plate 304, and the interaction of the plasmonic signals with the human FIG. 310 may cause variations in the S21 signal. The z-axis 312 may represent the depth position, which may be determined by analyzing the frequency response of the S21 signal.

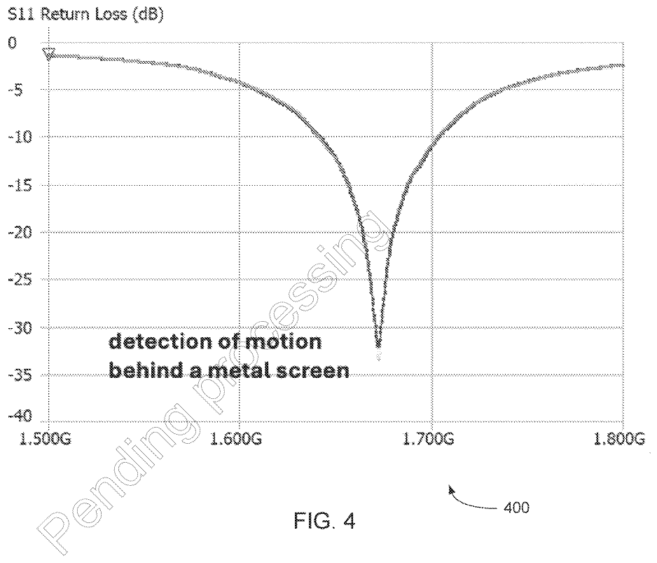

FIG. 4 shows a graph 400 illustrating the excitation of plasmon waves over the surface, which may be used for detection of motion behind a metal screen in accordance with various aspects of the present disclosure. The graph 400 may represent the return loss (S11) as a function of frequency, which may be used to analyze the behavior of plasmonic signals in the presence of a metal barrier. The graph 400 may demonstrate how the system may detect motion or objects located behind a metal shield by analyzing variations in the S11 parameter.

The horizontal axis of the graph 400 may represent frequency, measured in gigahertz (GHz), and may span a range from approximately 1.500 GHz to 1.800 GHz. The scale of the horizontal axis may be linear, allowing for a uniform representation of frequency intervals. The vertical axis of the graph 400 may represent the return loss (S11) in decibels (dB), with values ranging from 0 dB at the top to −40 dB at the bottom. The vertical axis may also employ a linear scale to facilitate the interpretation of signal attenuation.

The data points in the graph 400 may be represented as a continuous line, which may exhibit a distinct trend characterized by a pronounced dip or valley in the return loss. This valley may occur at approximately 1.675 GHz, where the return loss may reach its minimum value of approximately −34 dB. The presence of this valley may indicate a frequency at which the system may be particularly sensitive to motion or objects located behind the metal screen. The graph 400 may also show a gradual increase in return loss on either side of the valley, with values approaching −5 dB at the lower and upper frequency limits of the graph.

The line style used in the graph 400 may be solid, and the data may exhibit a smooth and continuous trend, suggesting a consistent and predictable relationship between frequency and return loss. The notable valley in the graph 400 may correspond to the detection of motion or objects behind the metal screen, as indicated by the accompanying annotation. This feature may highlight the system's ability to identify changes in the environment behind a conductive barrier by analyzing frequency-dependent variations in the S11 parameter. The dip may indicate that the energy has been transferred to the metal barrier. Variations on the dip may indicate the presence of an object.

The graph 400 may provide insight into the system's operational characteristics, particularly its ability to detect motion or objects behind a metal shield. The frequency at which the return loss reaches its minimum may be indicative of the system's sensitivity to specific spatial configurations or material properties. The smooth and continuous nature of the data may suggest that the system's response may be reproducible and reliable under similar conditions.

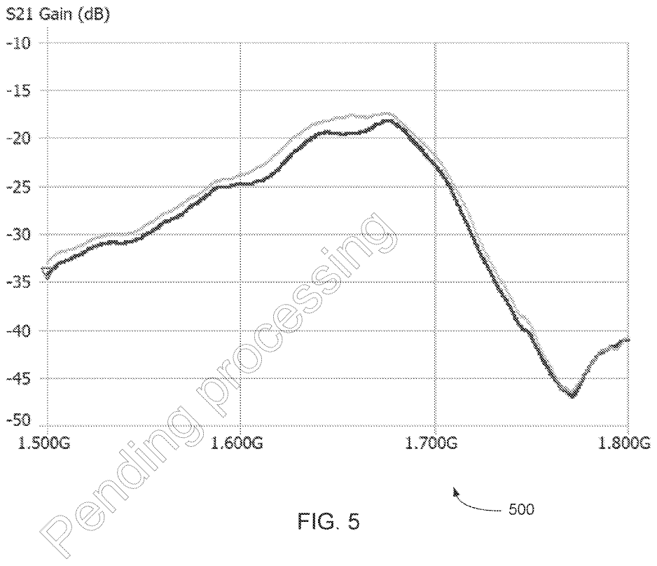

FIG. 5 shows a graph 500 illustrating the frequency response of the S21 gain (in decibels) as a function of frequency (in gigahertz) in accordance with various aspects of the present disclosure. The graph 500 may represent the behavior of plasmonic signals as they propagate around metal objects, enabling the determination of positional information for objects located behind a metal plate. The graph 500 may provide insight into how the S21 signal varies with frequency; which may be used to infer the depth (Z position) of an object behind a metal shield.

(The horizontal axis of the graph 500 may represent the frequency, labeled in gigahertz (GHz), and spans a range from approximately 1.500 GHz to 1.800 GHz. The scale of the horizontal axis may be linear, allowing for a uniform representation of frequency intervals. The vertical axis may represent the S21 gain, labeled in decibels (dB), and spans a range from approximately −10 dB to −50 dB. The vertical axis may also employ a linear scale, facilitating the interpretation of gain variations across the frequency range.

The data points in the graph 500 may be represented as continuous lines, with one line potentially corresponding to a reference measurement and another line corresponding to a measurement influenced by the presence of an object behind a metal plate. The lines may exhibit distinct patterns, including peaks and valleys, which may indicate frequency-dependent variations in the S21 gain. For example, the graph 500 may show a gradual increase in S21 gain from approximately −35 dB at 1.500 GHz to a peak near 1.700 GHz, followed by a sharp decline in gain to approximately −40 dB at 1.800 GHz. These features may suggest that the frequency response of the S21 signal is sensitive to the depth and material properties of the object being detected.

The graph 500 may include two distinct line styles to differentiate between the data sets. For instance, one line may be solid, while the other may be dashed or otherwise visually distinct. These line styles may allow for the comparison of the S21 gain under different conditions, such as with and without the presence of an object behind the metal plate. The relative alignment or divergence of the lines may provide additional information about the lateral (XY) position of the object.

The trends observed in the graph 500 may indicate that the frequency response of the S21 signal is a parameter for determining the Z position of an object behind a metal plate. The presence of peaks and valleys in the S21 gain may correspond to specific resonant frequencies or interference effects, which may be analyzed to extract positional information. The graph 500 may therefore serve as a representation of how plasmonic signals interact with metal barriers and objects, enabling the recovery of spatial information in challenging environments.

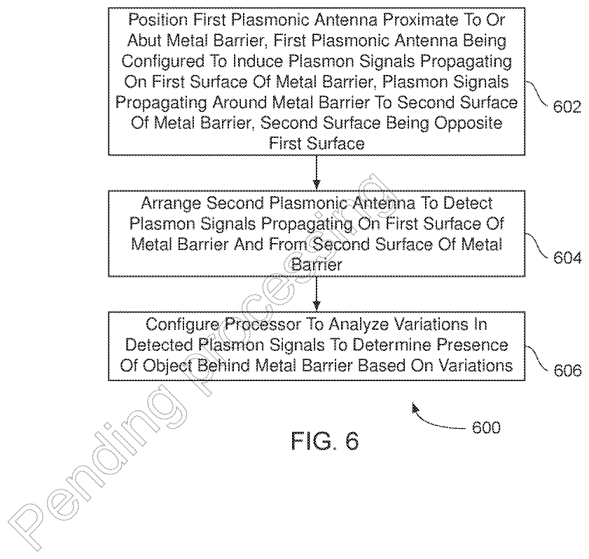

FIG. 6 shows a flowchart illustrating a method 600 involving detection of objects behind metal barriers with plasmonic antennas in accordance with various aspects of the present disclosure.

At 602, the method 600 may include positioning a first plasmonic antenna proximate to or abutting a metal barrier, the first plasmonic antenna being configured to induce plasmon signals propagating on a first surface of the metal barrier, the plasmon signals propagating around the metal barrier to a second surface of the metal barrier, the second surface being opposite the first surface. The operations of 602 may be performed in accordance with examples as disclosed herein. In some examples, aspects of the operations of 602 may involve one or more of a plasmonic GPR 210, a metal plate 202, and/or other components as described with reference to FIG. 2.

At 604, the method 600 may include arranging a second plasmonic antenna to detect the plasmon signals propagating on the first surface of the metal barrier and from the second surface of the metal barrier. The operations of 604 may be performed in accordance with examples as disclosed herein. In some examples, aspects of the operations of 604 may involve one or more of a plasmonic GPR 210, a metal plate 202, and/or other components as described with reference to FIG. 2.

At 606, the method 600 may include configuring a processor to analyze variations in the detected plasmon signals to determine a presence of an object behind the metal barrier based on the variations. The operations of 606 may be performed in accordance with examples as disclosed herein. In some examples, aspects of the operations of 606 may involve one or more of a human FIG. 208, a computer 212, and/or other components as described with reference to FIG. 2.

It should be noted that the methods described herein describe possible implementations, and that the operations and the steps may be rearranged or otherwise modified and that other implementations are possible. Furthermore, aspects from two or more of the methods may be combined.

Aspect 1: A plasmonic radar system, comprising: a first plasmonic antenna configured to induce plasmon signals propagating on a first surface of a metal barrier in response to being positioned proximate to or abutting the metal barrier, the plasmon signals propagating around the metal barrier to a second surface of the metal barrier, the second surface being opposite the first surface; a second plasmonic antenna configured to detect the plasmon signals propagating on the first surface of the metal barrier and from the second surface of the metal barrier; and a processor configured to analyze variations in the detected plasmon signals to determine a presence of an object behind the metal barrier based on the variations.

Aspect 2: The plasmonic radar system of aspect 1, further comprising a housing configured to position the first plasmonic antenna and the second plasmonic antenna proximate to the metal barrier.

Aspect 3: The plasmonic radar system of any of aspects 1 through 2, wherein the processor is further configured to analyze variations in high-frequency plasmon signals to enhance the detection of motion behind a metal screen.

Aspect 4: The plasmonic radar system of any of aspects 1 through 3, wherein the processor is further configured to analyze variations in low-frequency plasmon signals to enhance the detection of motion behind a metal screen.

Aspect 5: The plasmonic radar system of any of aspects 1 through 4, wherein the processor is further configured to analyze the high-frequency plasmon signals and the low-frequency plasmon signals to determine a distance of the object from the metal barrier.

Aspect 6: The plasmonic radar system of any of aspects 1 through 5, wherein the processor is further configured to determine the detection of motion behind a metal screen based on the frequency response of the detected plasmon signals.

Aspect 7: The plasmonic radar system of any of aspects 1 through 6, wherein the processor is further configured to determine a position of the object behind a metal screen based on a frequency response of the detected plasmon signals.

Aspect 8: The plasmonic radar system of any of aspects 1 through 7, further comprising a display configured to visually represent the presence of an object behind the metal barrier based on the analyzed variations.

Aspect 9: The plasmonic radar system of any of aspects 1 through 8, further comprising a display configured to visually present the detection of motion behind a metal screen based on the analyzed variations.

Aspect 10: The plasmonic radar system of any of aspects 1 through 9, wherein the processor is further configured to analyze variations in the detected plasmon signals to distinguish between stationary and moving objects behind the metal plate.

Aspect 11: The plasmonic radar system of any of aspects 1 through 10, wherein the processor is further configured to analyze variations in the detected plasmon signals to identify multiple objects behind the metal plate.

Aspect 12: The plasmonic radar system of any of aspects 1 through 11, wherein the processor is further configured to analyze variations in the detected plasmon signals to determine the size of an object behind the metal plate.

Aspect 13: The plasmonic radar system of any of aspects 1 through 12, wherein the processor is further configured to analyze variations in the detected plasmon signals to differentiate between high-frequency plasmon and low-frequency plasmon responses.

Aspect 14: The plasmonic radar system of any of aspects 1 through 13, wherein the processor is further configured to analyze variations in the detected plasmon signals to determine the relative speed of motion of an object behind the metal plate.

Aspect 15: The plasmonic radar system of any of aspects 1 through 14, wherein the processor is further configured to analyze variations in the detected plasmon signals to provide a three-dimensional representation of motion behind the metal plate.

Aspect 16: A method of forming a plasmonic radar system, comprising: positioning a first plasmonic antenna proximate to or abutting a metal barrier, the first plasmonic antenna being configured to induce plasmon signals propagating on a first surface of the metal barrier, the plasmon signals propagating around the metal barrier to a second surface of the metal barrier, the second surface being opposite the first surface; arranging a second plasmonic antenna to detect the plasmon signals propagating on the first surface of the metal barrier and from the second surface of the metal barrier; and configuring a processor to analyze variations in the detected plasmon signals to determine a presence of an object behind the metal barrier based on the variations.

Aspect 17: The method of aspect 16, further comprising incorporating a housing configured to position the first plasmonic antenna and the second plasmonic antenna proximate to the metal barrier.

Aspect 18: The method of any of aspects 16 through 17, further comprising configuring the processor to analyze variations in high-frequency plasmon signals to enhance the detection of motion behind a metal screen.

Aspect 19: The method of any of aspects 16 through 18, further comprising configuring the processor to analyze variations in low-frequency plasmon signals to enhance the detection of motion behind a metal screen.

Aspect 20: The method of any of aspects 16 through 19, further comprising configuring the processor to analyze the high-frequency plasmon signals and the low-frequency plasmon signals to determine a distance of the object from the metal barrier.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A plasmonic radar system, comprising:
a first plasmonic antenna configured to induce plasmon signals propagating on a first surface of a metal barrier in response to being positioned proximate to or abutting the metal barrier, the plasmon signals propagating around the metal barrier to a second surface of the metal barrier, the second surface being opposite the first surface;
a second plasmonic antenna configured to detect the plasmon signals propagating on the first surface of the metal barrier and from the second surface of the metal barrier; and
a processor configured to analyze variations in the detected plasmon signals to determine a presence of an object behind the metal barrier based on the variations.

2. The plasmonic radar system of claim 1, further comprising a housing configured to position the first plasmonic antenna and the second plasmonic antenna proximate to the metal barrier.

3. The plasmonic radar system of claim 1, wherein the processor is further configured to analyze variations in high-frequency plasmon signals to enhance the detection of motion behind a metal screen.

4. The plasmonic radar system of claim 3, wherein the processor is further configured to analyze variations in low-frequency plasmon signals to enhance the detection of motion behind a metal screen.

5. The plasmonic radar system of claim 4, wherein the processor is further configured to analyze the high-frequency plasmon signals and the low-frequency plasmon signals to determine a distance of the object from the metal barrier.

6. The plasmonic radar system of claim 1, wherein the processor is further configured to determine the detection of motion behind a metal screen based on the frequency response of the detected plasmon signals.

7. The plasmonic radar system of claim 1, wherein the processor is further configured to determine a position of the object behind a metal screen based on a frequency response of the detected plasmon signals.

8. The plasmonic radar system of claim 1, further comprising a display configured to visually represent the presence of an object behind the metal barrier based on the analyzed variations.

9. The plasmonic radar system of claim 1, further comprising a display configured to visually present the detection of motion behind a metal screen based on the analyzed variations.

10. The plasmonic radar system of claim 1, wherein the processor is further configured to analyze variations in the detected plasmon signals to distinguish between stationary and moving objects behind the metal plate.

11. The plasmonic radar system of claim 1, wherein the processor is further configured to analyze variations in the detected plasmon signals to identify multiple objects behind the metal plate.

12. The plasmonic radar system of claim 1, wherein the processor is further configured to analyze variations in the detected plasmon signals to determine the size of an object behind the metal plate.

13. The plasmonic radar system of claim 1, wherein the processor is further configured to analyze variations in the detected plasmon signals to differentiate between high frequency plasmon and low frequency plasmon responses.

14. The plasmonic radar system of claim 1, wherein the processor is further configured to analyze variations in the detected plasmon signals to determine the relative speed of motion of an object behind the metal plate.

15. The plasmonic radar system of claim 1, wherein the processor is further configured to analyze variations in the detected plasmon signals to provide a three-dimensional representation of motion behind the metal plate.

16. A method of forming a plasmonic radar system, comprising:
positioning a first plasmonic antenna proximate to or abutting a metal barrier, the first plasmonic antenna being configured to induce plasmon signals propagating on a first surface of the metal barrier, the plasmon signals propagating around the metal barrier to a second surface of the metal barrier, the second surface being opposite the first surface;
arranging a second plasmonic antenna to detect the plasmon signals propagating on the first surface of the metal barrier and from the second surface of the metal barrier; and
configuring a processor to analyze variations in the detected plasmon signals to determine a presence of an object behind the metal barrier based on the variations.

17. The method of forming a plasmonic radar system of claim 16, further comprising incorporating a housing configured to position the first plasmonic antenna and the second plasmonic antenna proximate to the metal barrier.

18. The method of forming a plasmonic radar system of claim 16, further comprising configuring the processor to analyze variations in high-frequency plasmon signals to enhance the detection of motion behind a metal screen.

19. The method of forming a plasmonic radar system of claim 16, further comprising configuring the processor to analyze variations in low-frequency plasmon signals to enhance the detection of motion behind a metal screen.

20. The method of forming a plasmonic radar system of claim 16, further comprising configuring the processor to analyze the high-frequency plasmon signals and the low-frequency plasmon signals to determine a distance of the object from the metal barrier.
